(19) United States
(12) Patent Application Publication
(10) Pub. No.: US 2003/0126794 A1
(43) Pub. Date: Jul. 10, 2003

(54) Thermoplastic garden stake

(76) Inventor: John M. Wisniewski, Wauwatosa, WI (US)

Correspondence Address: QUARLES & BRADY LLP, 411 E. WISCONSIN AVENUE, SUITE 2040, MILWAUKEE, WI, 53202-4497, US

(21) Appl. No.: 10/337,051

(22) Filed: Jan. 3, 2003

Related U.S. Application Data
(60) Provisional application No. 60/346,927, filed on Jan. 10, 2002.

(51) Int. Cl. A01G 17/06; A01G 17/14

(52) U.S. Cl. 47/47

(57) ABSTRACT

Practical injection molded plastic garden stakes use a ribbed cross-section with contained core displaced of thermoplastic by air, foam or the like. Integrally molded notches for fencing, hooks for plants, and holes for cords are provided on the ribs.

### CROSS-REFERENCE TO RELATED APPLICATIONS

This application is based on and claims the benefit of U.S. Provisional application No. 60/346,927 entitled Fence Post for Gardening and filed Jan. 10, 2002.

### STATEMENT REGARDING FEDERALLY SPONSORED RESEARCH OR DEVELOPMENT

--

### BACKGROUND OF THE INVENTION

The present invention relates to garden stakes and, in particular, to a molded plastic garden stake providing improved support features.

Garden stakes may be used to support garden plants and fences surrounding the plants of a garden. For these purposes, wooden or bamboo garden stakes are frequently used as well as rods of different materials including metal. Plant stems may be tied to the garden stakes or trained to attach themselves to the garden stake, as in the case with vines having tendrils.

Garden stakes may support fences that may be tied to the garden stakes, or held by staples or the like, for example, when wooden garden stakes are used. It is known to support fences with posts made of metal channels having formed hooks. The expense and size of these channels make them unsuitable for most gardening applications.

Wooden garden stakes are subject to rotting and splintering and, when cheaply made, can make a garden look unkempt. Garden stakes constructed of metal are relatively expensive and, to counter the expense, tend to be thin and thus easily bent. The metal is subject to rusting and it can be difficult to loosely tie plant stems to its smooth and hard surface.

### BRIEF SUMMARY OF THE INVENTION

The present invention provides an injection-molded garden stake that provides molded-in features improving the function of the garden stake for fencing and plant stabilization. Critical to the ability to use molded plastic in this cost sensitive application is a design that reduces the amount of plastic required in each garden stake while nevertheless producing a garden stake with great strength. The resulting design not only provides improved support features and low cost, but is more attractive and durable than wooden and metal alternatives.

Specifically, the present invention provides a garden stake comprising a shaft of molded thermoplastic extending along a longitudinal axis and having a first blunt end and a second tapered end forming a point for insertion into the garden soil. The shaft between the first and second ends has a central core where the thermoplastic is largely displaced by air.

Thus, it is one object of the invention to provide a practical thermoplastic garden stake that has sufficient strength and yet which uses plastic materials sparingly. The core moves plastic material to the edges of the garden stake where the plastic provides for greater rigidity and provides a cross section that resists torsion.

It is another object of the invention to provide a garden stake that may be easily inserted into the ground.

The garden stake may include at least one longitudinal rib extending outwardly from the shaft. In one embodiment, the garden stake includes four longitudinally extending ribs spaced about the shaft 90°.

It is thus another object of the invention to preferentially move plastic material away from the center of the shaft to a location where it can make a greater contribution in providing shaft stiffness while also minimizing the cross-sectional area of the garden stake which affects the amount of dirt that needs to be displaced when the garden stake is inserted into the garden, and hence the resistance of the garden stake to such insertion. The ribs may also provide a support for additional features not normally provided in a conventional solid garden stake and help resist movement of the garden stake in the soil once it is so inserted.

The garden stake may include at least one outwardly extending notch each sized to receive at least one transversely extending fence wire. Multiple outwardly extending notches may be spaced along the shaft, each sized to receive transversely extending fence wires.

Thus, it is another object of the invention to eliminate the need for separate ties or fasteners to attach fencing to the garden stake, to accommodate multiple different types of manufactured fence cloth of different wire spacings, and/or to allow the garden stake to be inserted into the ground to different heights with the fence adjusted accordingly.

The notches may be of two orientations: notches opening upward toward the blunt end and positioned proximate to the blunt end and notches opening downward toward the tapered end and positioned near the tapered end.

Thus, it is another object of the invention to provide a notch system that may retain a fence using the inherent flexure of the fence wire to retain the fence to the garden stake.

The garden stake may include at least one outwardly extending hook sized to receive a longitudinally extending plant stem.

Thus, it is another object of the invention to eliminate the need for separate ties for holding plants to the garden stakes.

The garden stake may include a series of outwardly extending hooks curving about the longitudinal axis and sized to receive longitudinally extending plant stalks that are inserted into the hook along a reception direction being transverse and tangent to the shaft wherein the hooks are oriented to have opposed reception directions so that a plant stalk may be woven between the hooks.

Thus it is another object of the invention to provide a plant support that does not unduly constrain growth of the plant or constrict increase in diameter of the stem such as may occur with ties or the like.

The garden stake may include a step surface integrally molded to the garden stake extending outward from the shaft above the pointed end and below the blunt end providing a surface for receiving a downward force.

Thus, it is another object of the invention to incorporate a means for planting the garden stakes by the user placing the user's foot upon the step surface while stabilizing the garden stake by grasping its blunt end.

At least one rib may include at least one transverse hole receiving a cord or the like.

Thus, it is another object of the invention to provide for an alternative method of affixing material or plants to the garden stake. It is a further object of the invention to provide for holes not entering into the core.

The garden stakes may be greater than twenty inches in length and less than sixty inches in length and the thermoplastic may include a filler material.

Thus, it is another object of the invention to provide for large sized garden stakes for suitable stiffness without undue plastic expense.

The filler material may be glass fiber; the thermoplastic may be recycled in origin.

Thus, it is another object of the invention to provide a garden stake user an inexpensive garden stake using environmentally friendly materials.

The blunt end may include a cap presenting a surface substantially perpendicular to the length of the shaft for accepting a force along the length for inserting the garden stake into the garden for stabilizing it.

Thus, it is another object of the invention to provide for a convenient surface for the user to press down upon independent of the cross-section of the garden stake allowing the garden stake cross-section to be reduced for easier insertion.

These particular objects and advantages may apply to only some embodiments falling within the claims and thus do not define the scope of the invention.

### BRIEF DESCRIPTION OF THE DRAWINGS

FIG. 1 is a side elevational view of a garden stake prior to insertion into the ground; and

FIG. 2 is a fragmentary perspective view of the garden stake showing the notches and hooks extending therefrom for attachment to wire fencing or plant stems and the like and showing in cross-section the hollow center produced by gas-assisted injection molding.

### DETAILED DESCRIPTION OF THE PREFERRED EMBODIMENT

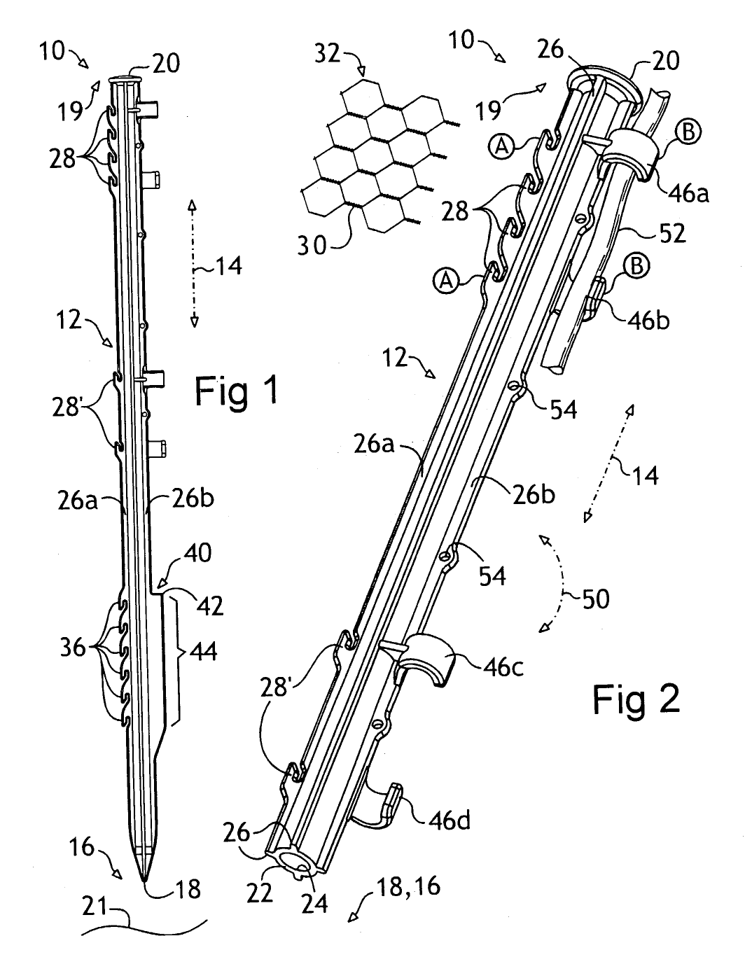

Referring now to FIG. 1, a garden stake 10 of the present invention provides a molded thermoplastic shaft 12 extending generally along a longitudinal axis 14. A first tapered end 16 of the shaft 12 narrows generally to a point 18 whereas the opposed second blunt end 19 of the shaft 12 is terminated by a cap 20.

The point 18 provides a reduced cross-section facilitating initial insertion of the garden stake 10 into the soil 21 of the garden and the taper of the tapered end 16 provides a wedge opening up and compacting the soil around the garden stake 10 as it is further inserted.

The cap 20 provides a flat upper surface perpendicular to the longitudinal axis 14 and will generally be on top of the shaft 12 with respect to the point 18 before the point is inserted into the soil 21 of the garden.

Referring now to FIGS. 1 and 2, a central portion of the shaft 12 provides a tubular center section 22 having an air filled core 24 along the longitudinal axis 14.

A series of ribs 26 extend longitudinally along the shaft 12 between the point 18 and cap 20 and project radially outward from the tubular center section 22 at equally spaced 90° intervals. The ribs 26 taper at the first tapered end 16 to converge at the point 18 and support the underside of the cap 20 at the blunt end 19.

The ribs 26 serve a number of other purposes including providing points for fastening plants and fencing to the garden stake 10 through holes and hooks to be described, but also in moving plastic material of the center core 24 of the garden stake 10 to form the ribs 26 and thereby to provide bending rigidity to the garden stake 10 with a reduced amount of material. The spacing of the ribs 26 at 90° intervals ensures that two ribs 26 will be positioned to best resist movement of the garden stake 10 in the soil 21 both against forces along an attached fence (to be described) or perpendicular to the attach fence.

The tubular center section 22 provides a resistance to twisting of the garden stake 10 while the ribs 26 resist twisting within the soil and minimize the total cross-sectional area of the garden stake 10 that must be forced through the soil 21.

Referring now generally to FIG. 2, one of the ribs 26a extending downward from the cap 20 may include a number of outwardly projecting notches 28 upwardly extending and sized to receive a transverse wire 30 of conventional hexagonal or rectangular mesh fence.

The spacing of the notches 28 is such as to accommodate different fence materials 32 having different spacings of their transverse wires 30, and/or to accommodate different heights of fences, and/or to allow different insertion depths of the garden stake 10 into the soil 21 with corresponding freedom of adjustment of fence height. Upper transverse wires 30 of the fence materials 32 are inserted into one or more of the series of notches 28 and middle transverse wires 30 of the fence material are inserted into notches 28′ further down the shaft 12 to prevent the fencing material from bowing out. Notches 28′ also allow substantially shorter wire fences to be attached to the garden stakes 12.

Referring now to FIG. 1, a second set of outwardly projecting notches 36 are downwardly extending lower on the shaft 12 above the tapered end 16 and sized to receive transverse wires 30 near the bottom of the shaft 12 to capture lower transverse wires 30 of the fence materials 32 so that the fencing material may be stretched between the notches 28 and the hooks 36 to be retained within the notches by natural contractive flexure of the fence materials 32.

Referring to FIG. 1, rib 26b opposite rib 26a may include an outward jutting step 40 capped by horizontal foot plate 42 for receiving the user's foot for pressing the garden stake 10 into the soil 21 or for receiving a pusher rod or board that may be used for the same effect. When the user is pressing the garden stake 10 into the soil 21 with the user's foot, the user may rest his or her hand on cap 20 to stabilize the garden stake 10 or to provide additional downward pressure. Referring again to FIG. 1, the cap 20 may be a circular disk perpendicular to the longitudinal axis and having a radius such that the cap 20 covers the tubular center section 22 and the ribs 26 providing a surface that the user may grasp and on which downward pressure along the longitudinal axis 14 also may be applied. Below the plate 42, the rib 26b extends radially further out from shaft 12 in a stabilization region 44 to provide greater ability to resist the pressure placed on the step 40.

Referring again to FIG. 2, rib 26b also supports C-shaped hooks 46a through 46d curling about a longitudinal axis 14 opening along a tangential transverse axis 50 to receive a vertically oriented plant stem 52 or the like. Hooks 46a through 46d face in opposite directions to receive the plant stem from opposing directions along the transverse axis 50 thus allowing retention of the plant stem 52 without undue pressure on the plant stem 52 which may be woven between the hooks 42a through 42d. Importantly, this system allows growth in the stem 52 to be accommodated and strangulation of the stem 52 such as may occur with wire ties or the like, to be prevented.

Rib 26b also includes through holes 54 through which conventional ties may be inserted for a variety of uses.

Each of the elements of the garden stake 10 so far described, including the tubular center section 22, the ribs 26, notches 28 and 36, the hooks 46 and, the cap 20 may be assembled from parts or preferably molded in a single piece of thermoplastic using gas-assisted injection molding as is understood in the art. An alternate embodiment of the invention may include the use of structural foam injection molding to achieve a porous center with a solid outer skin producing a low-weight part with high comparative strength and the same molded-in features.

The thermoplastic material may be, for example, recycled polyester and may include filler such as glass fiber to further decrease the total cost of the garden stake 10 and increase its strength. The thermoplastic may be colored green so as to comport with the environment in which the garden stake 10 is used and to require no further finishing.

During manufacture, four garden stakes 10 may be simultaneously molded and joined to each other (not shown) with points A on hooks 46 on a first garden stake 10 attached by a thin breakable molded link to points B on hooks 28 on a second garden stake 10. Four such garden stakes may be connected together and simultaneously molded and broken apart by flexure by the consumer. A cardboard sleeve and other packing material may be wrapped around the hooks to further retain them.

It is specifically intended that the present invention not be limited to the embodiments and illustrations contained herein, but include modified forms of those embodiments including portions of the embodiments and combinations of elements of different embodiments as come within the scope of the following claims.

I claim:

1. A garden stake comprising a shaft of molded thermoplastic extending along a longitudinal axis and having a first blunt end and a second tapered end forming a point for insertion into the garden, the shaft between the first and second ends having a central core displacing the thermoplastic.

2. The garden stake of claim 1 wherein the core is selected from the group consisting of gas and thermoplastic foam.

3. The garden stake of claim 1 further including at least one longitudinal rib extending outwardly from the shaft.

4. The garden stake of claim 1 including four longitudinal ribs extending outward from the shaft and spaced about the shaft at substantially 90 degrees.

5. The garden stake of claim 1 including at least one outwardly extending notch sized to receive at least one transversely extending fence wire.

6. The garden stake of claim 1 including a series of outwardly extending notches spaced longitudinally along the shaft and each sized to receive at least one transversely extending fence wire.

7. The garden stake of claim 1 wherein the series of notches are divided into notches opening upward toward the blunt end and positioned proximate to the blunt end and notches opening toward the pointed end and positioned proximate to the pointed end.

8. The garden stake of claim 1 including at least one outwardly extending hook curving about the longitudinal axis and sized to receive a longitudinally extending plant stem.

9. The garden stake of claim 7 including a series of outwardly extending hooks sized to receive a longitudinally extending plant stalk inserted into the hook along a reception direction being a transverse tangent to the shaft wherein the hooks are oriented to have opposed reception directions whereby the plant stem may be woven between the hooks.

10. The garden stake of claim 1 including a step surface extending outwardly from shaft above the pointed end and below the blunt end providing a surface for receiving a downward force.

11. The garden stake of claim 2 wherein the rib includes at least one transverse hole for receiving a cord or the like.

12. The garden stake of claim 1 wherein the garden stakes are greater than twenty inches in length wherein the thermoplastic includes a filler material.

13. The garden stake of claim 1 wherein the filler material is glass fiber.

14. The garden stake of claim 1 wherein the thermoplastic is recycled plastic.

15. The garden stake of claim 1 wherein the blunt end includes a cap presenting a surface substantially perpendicular to the length of the shaft for accepting a force along the length for inserting the garden stake into the garden.
